(19) United States
(12) Patent Application Publication
(10) Pub. No.: US 2016/0343498 A1
(43) Pub. Date: Nov. 24, 2016

(54) COIL COMPONENT AND MANUFACTURING METHOD THEREOF

(71) Applicant: SAMSUNG ELECTRO-MECHANICS CO., LTD., Suwon-si (KR)

(72) Inventors: Dong Hwan LEE, Suwon-si (KR); Chan YOON, Suwon-si (KR); Moon Soo PARK, Suwon-si (KR); Hye Yeon CHA, Suwon-si (KR); Byeong Cheol MOON, Suwon-si (KR)

(21) Appl. No.: 15/000,252

(22) Filed: Jan. 19, 2016

(30) Foreign Application Priority Data
May 19, 2015 (KR) 10-2015-0069907

(51) Int. Cl. H01F 27/255; H01F 27/245; H01F 41/02

(52) U.S. Cl. CPC H01F 27/255; H01F 41/0233; H01F 27/245

(57) ABSTRACT

A coil component includes a coil unit surrounded by a magnetic body. The magnetic body includes anisotropic metal powder and isotropic metal powder, and upper and lower cover units with the coil unit interposed therebetween. The anisotropic metal powder is arranged such that one axis of a plate-shaped plane thereof is oriented in a flow direction of magnetic flux, and central regions of the upper and lower cover units comprise the isotropic metal powder.

### CROSS-REFERENCE TO RELATED APPLICATION

This application claims the benefit of priority to Korean Patent Application No. 10-2015-0069907, filed on May 19, 2015 with the Korean Intellectual Property Office, the entirety of which is incorporated herein by reference.

### TECHNICAL FIELD

The present disclosure relates to a coil component and a manufacturing method thereof.

### BACKGROUND

An inductor, a type of coil component, is a type of passive device forming an electronic circuit, together with a resistor and a capacitor, to cancel noise therefrom.

An inductor is manufactured by forming a coil unit, curing a magnetic powder-resin complex, a mixture of magnetic powder and a resin, to form a magnetic body surrounding the coil unit, and subsequently forming external electrodes on external surfaces of the magnetic body.

### SUMMARY

An aspect of the present disclosure provides a coil component having high inductance (L) and an excellent quality (Q) factor and DC-bias characteristics (characteristics of inductance that change according to current application).

According to an aspect of the present disclosure, a coil component includes a coil unit surrounded by a magnetic body. The magnetic body includes anisotropic metal powder and isotropic metal powder, and upper and lower cover units with the coil unit interposed therebetween. The anisotropic metal powder is arranged such that one axis of a plate-shaped plane thereof is oriented in a flow direction of magnetic flux, and central regions of the upper and lower cover units comprise the isotropic metal powder.

The anisotropic metal powder may be comprised in at least one of the upper cover unit and the lower cover unit in a region corresponding to the coil unit.

The anisotropic metal powder may be arranged such that one axis of a plate-shaped plane thereof is perpendicular to a thickness direction of the coil unit.

The anisotropic metal powder may be comprised in a core part formed in the middle of the coil unit.

The anisotropic metal powder may be comprised in an outer circumferential portion formed on an outer surface of the coil unit.

The anisotropic metal powder may be arranged such that one axis of a plate-shaped plane thereof is parallel to a thickness direction of the coil unit.

The anisotropic metal powder may be arranged such that one axis of a plate-shaped plane thereof is parallel to a thickness direction of the coil unit.

The anisotropic metal powder may be comprised in a toroidal sheet and disposed in a region corresponding to the coil unit in the first and second cover units.

The anisotropic metal powder and the isotropic metal powder may be included in a thermosetting resin in a dispersed manner.

A method of manufacturing a coil component comprises: forming a coil unit, and surrounding the coil unit with a magnetic body comprising anisotropic metal powder and isotropic metal powder. The anisotropic metal powder may be arranged such that one axis of a plate-shaped plane thereof is oriented in a flow direction of magnetic flux, and the isotropic metal powder may be comprised in central regions of first and second cover units disposed with the coil unit interposed therebetween.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating a coil component such that a coil unit thereof is illustrated according to an exemplary embodiment in the present disclosure;

FIG. 2 is a cross-sectional view of the coil component of FIG. 1, taken along line I-I′ of FIG. 1;

FIG. 3A is an enlarged perspective view of an isotropic metal powder particle;

FIG. 3B is an enlarged perspective view of an anisotropic metal powder particle;

FIG. 4 is a cross-sectional view of the coil component of FIG. 1, taken along line II-II′ of FIG. 1;

FIG. 5 is a perspective view illustrating a coil component such that a coil unit and a sheet including anisotropic metal powder are illustrated according to an exemplary embodiment in the present disclosure;

FIGS. 6 and 7 are cross-sectional views of a coil component in the length and thickness directions according to another exemplary embodiment in the present disclosure; and

FIGS. 8A through 8C are views sequentially illustrating a process of manufacturing a coil component according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Coil Component

Hereinafter, a thin film type inductor will be described as an example of a coil component according to an exemplary embodiment in the present disclosure, but the coil component is not limited thereto.

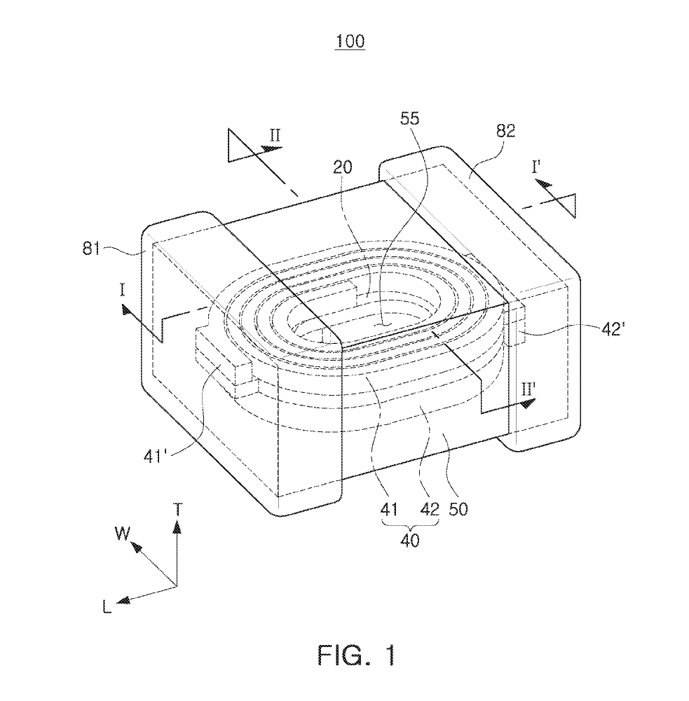

FIG. 1 is a perspective view illustrating a coil component such that a coil unit thereof is illustrated according to an exemplary embodiment in the present disclosure.

Referring to FIG. 1, a thin film type power inductor used in a power line of a power supply circuit is disclosed as an example of a coil component.

A coil component 100 according to an exemplary embodiment in the present disclosure includes a coil unit 40, a magnetic body 50 surrounding the coil unit 40, and first and second external electrodes 81 and 82 disposed on external surfaces of the magnetic body 50 and connected to the coil unit 40.

In the coil component 100 according to an exemplary embodiment in the present disclosure, it is defined that the length direction is the “L” direction, the width direction is the “W” direction, and the thickness direction is the “T” direction in FIG. 1.

The coil unit 40 is formed as a first coil conductor 41 formed on a first surface of a substrate 20 and a second coil conductor 42 formed on a second surface of the substrate 20 opposing the first surface thereof is connected thereto.

The first and second coil conductors 41 and 42 may have a planar coil shape formed on the same plane as that of the substrate 20.

The first and second coil conductors 41 and 42 may have a spiral shape.

The first and second coil conductors 41 and 42 may be formed on the substrate 20 through electroplating, but the method of forming the first and second coil conductors 41 and 42 is not limited thereto.

The first and second coil conductors 41 and 42 may include a metal having excellent electrical conductivity. For example, the first and second coil conductors 41 and 42 may contain silver (Ag), palladium (Pd), aluminum (Al), nickel (Ni), titanium (Ti), gold (Au), copper (Cu), platinum (Pt), or alloys thereof.

The first and second coil conductors 41 and 42 may be covered with an insulating film (not shown) so as not to be in direct contact with a magnetic material forming the magnetic body 50.

The substrate 20 is formed as a polypropyleneglycol (PPG) substrate, a ferrite substrate, or a metal-based soft magnetic substrate.

A central portion of the substrate 20 is removed to form a through hole, and the through hole is filled with a magnetic material to form a core part 55 in the middle of the coil unit 40.

The core part 55 is filled with a magnetic material, increasing an area of the magnetic body 50 through which magnetic flux passes, thereby enhancing inductance (L).

The substrate 20 is not essential and the coil unit 40 may be formed of a metal wire without the substrate 20.

The magnetic body 50 surrounding the coil unit 40 may include any magnetic material as long as it exhibits magnetic characteristics without limitation. For example, the magnetic body 50 may include ferrite or a magnetic metal powder.

As the magnetic permeability of the magnetic material included in the magnetic body 50 is increased and as an area of the magnetic body 50 through which magnetic flux passes is increased, inductance (L) may be enhanced.

One end of the first coil conductor 41 extends to form a first lead-out portion 41′. The first lead-out portion 41′ is exposed to a first end surface of the magnetic body 50 in the length (L) direction. One end of the second coil conductor 42 extends to form a second lead-out portion 42′. The second lead-out portion 42′ is exposed to a second end surface of the magnetic body 50 in the length (L) direction.

However, the configuration is not limited thereto and the first and second lead-out portions 41′ and 42′ may be exposed to at least one surface of the magnetic body 50.

The first and second external electrodes 81 and 82 are formed on external surfaces of the magnetic body 50 such that the first and second external electrodes 81 and 82 are connected to the first and second lead-out portions 41′ and 42′ exposed to end surfaces of the magnetic body 50, respectively.

The first and second external electrodes 81 and 82 may contain a metal having excellent electrical conductivity. For example, the first and second external electrodes 81 and 82 may contain copper (Cu), silver (Ag), nickel (Ni), or tin (Sn) alone, or may contain alloys thereof.

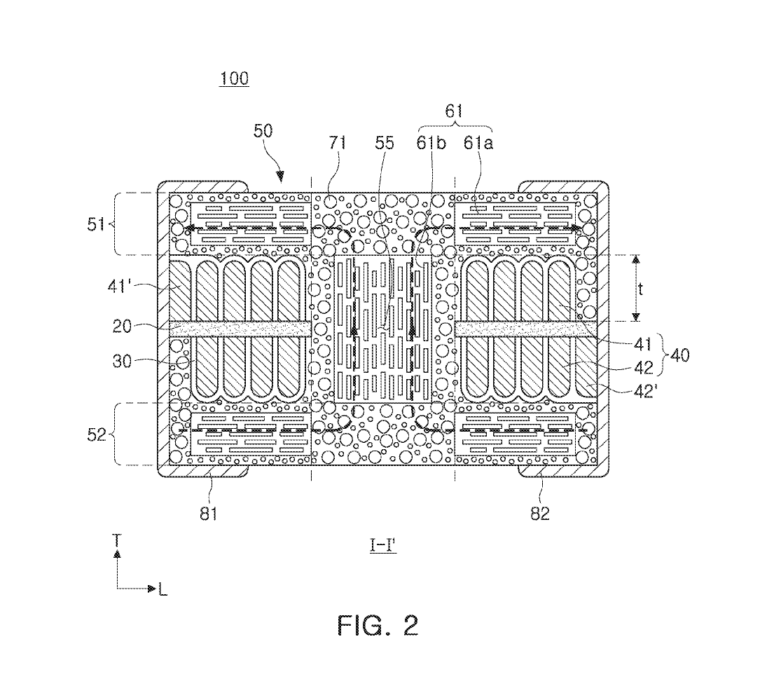

FIG. 2 is a cross-sectional view of the coil component of FIG. 1, taken along line I-I′ of FIG. 1.

Referring to FIG. 2, the magnetic body 50 of the coil component 100 according to an exemplary embodiment in the present disclosure includes both an anisotropic metal powder 61 and an isotropic metal powder 71.

The anisotropic metal powder 61 and the isotropic metal powder 71 may contain a metal including one or more selected from the group consisting of iron (Fe), silicon (Si), boron (B), chromium (Cr), aluminum (Al), copper (Cu), niobium (Nb), and nickel (Ni), or alloys thereof, and may be a crystalline metal or an amorphous metal.

For example, the anisotropic metal powder 61 or the isotropic metal powder 71 may be a Fe—Si—Cr-based amorphous metal, but the material thereof is not limited thereto.

The anisotropic metal powder 61 and the isotropic metal powder 71 may be included in a form of being dispersed in a thermosetting resin.

The thermosetting resin may be, for example, epoxy or polyimide.

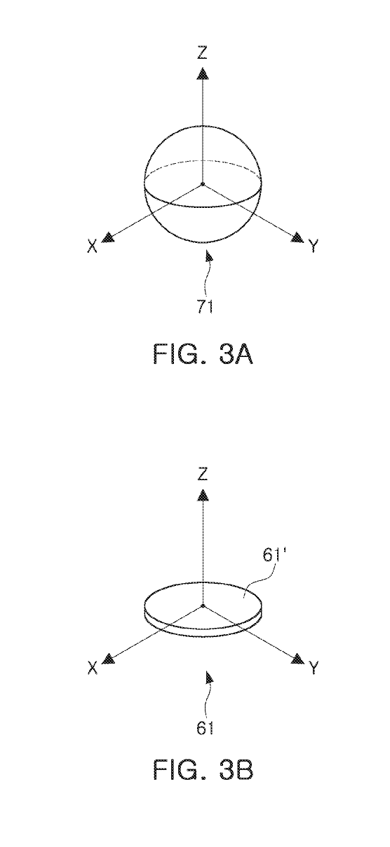

FIG. 3A is an enlarged perspective view of an isotropic metal powder particle, and FIG. 3B is an enlarged perspective view of an anisotropic metal powder particle.

Referring to FIG. 3A, the isotropic metal powder 71 may have a spherical shape. In this manner, when the same characteristics have the same magnitude inthe X axis, Y axis, and Z axis directions, it may be called shape isotropy.

The isotropic metal powder 71 has the same magnetic permeability in the X axis, Y axis, and Z axis directions.

In contrast, the anisotropic metal powder 61 has different characteristics in the X axis, Y axis, and Z axis directions.

For example, the anisotropic metal powder 61 may have plate-shaped metal powder particles, as illustrated in FIG. 3B.

In general, the anisotropic metal powder 61 has magnetic permeability higher than that of the isotropic metal powder 71. Thus, in the past, coil components were manufactured using a sheet including the anisotropic metal powder 61 having magnetic permeability higher than that of the isotropic metal powder 71 in order to enhance inductance (L).

However, the magnetic permeability of the anisotropic metal powder 61 differs according to the direction. Thus, even though overall magnetic permeability of the anisotropic metal powder 61 is higher than that of the isotropic metal powder 71, magnetic permeability thereof in a particular direction may be very low, so that it may hinder the flow of magnetic flux generated by a current applied to the coil unit 40.

For example, in the anisotropic metal powder 61 illustrated in FIG. 3B, the magnetic permeability in the X axis and Y axis directions on one axis of a plate-shaped plane 61′ is high, but that in the Z axis direction is very low. Thus, the anisotropic metal powder 61 may hinder a flow of magnetic flux in the Z axis direction, perpendicular to one axis of a plate-shaped plane 61′, which results in a reduction in inductance (L).

Thus, in an exemplary embodiment in the present disclosure, as illustrated in FIG. 2, the anisotropic metal powder 61 is arranged such that one axis of a plate-shaped plane 61′ is oriented in a flow direction of magnetic flux, and the isotropic metal powder 71 is disposed in upper and lower portions of the core part 55 in the first and second cover units and 52 disposed with the coil unit 40 interposed therebetween.

The anisotropic metal powder 61 has high magnetic permeability in the direction of one axis of a plate-shaped plane 61′, and thus, the anisotropic metal powder 61 is arranged such that one axis of a plate-shaped plane 61′ is oriented in a flow direction of magnetic flux to allow magnetic flux to smoothly flow and enhance inductance (L) through high magnetic permeability. Also, excellent Q factor and DC-bias characteristics may be obtained with a high saturation magnetization value (Ms) in the anisotropic metal powder 61.

In the related art, when the anisotropic metal powder 61 is included in the first and second cover units 51 and 52 disposed with the coil unit 40 interposed therebetween, in order to make the anisotropic metal powder 61 arranged to be oriented in a flow direction of magnetic flux, generally, the anisotropic metal powder 61 is arranged such that one axis of a plate-shaped plane 61′ is perpendicular to a thickness (t) direction of the coil unit 40 in the entirety of the first and second cover units 51 and 52.

However, when the anisotropic metal powder 61 is arranged such that one axis of a plate-shaped plane 61′ is perpendicular to the thickness (t) direction of the coil unit 40 in the entirety of the first and second cover units 51 and 52, the anisotropic metal powder 61 included in upper and lower portions of the core part 55 in the cover units 51 and 52 hinders a flow of magnetic flux.

Here, it may be desirable to arrange even the anisotropic metal powder 61 included in the upper and lower portions of the core part 55 in the cover units 51 and 52 such that one axis of a plate-shaped plane 61 is oriented in the flow direction of magnetic flux. However, the flow direction of magnetic flux is greatly changed in the upper and lower portions of the core part 55, and thus, it is substantially difficult to arrange the anisotropic metal powder 61 to be oriented in the flow direction of magnetic flux in the upper and lower portions of the core part 55 in the cover units 51 and 52.

Thus, in an exemplary embodiment in the present disclosure, the anisotropic metal powder 61 is not provided in the entirety of the first and second cover units 51 and 52. That is, portions of the first and second cover units 51 and 52 include the anisotropic metal powder 61 such that one axis of a plate-shaped plane 61′ is oriented in the flow direction of the magnetic flux, and the upper and lower portions of the core part 55 in which the flow direction of magnetic flux is greatly changed include the isotropic metal powder 71.

Thus, flow of magnetic flux is prevented from being hindered by the anisotropic metal powder 61 in the upper and lower portions of the core part 55, and magnetic flux is allowed to flow more smoothly to obtain higher inductance (L).

The coil component 100 according to an exemplary embodiment in the present disclosure illustrated in FIG. 2 includes the anisotropic metal powder 61a in the upper and lower portions of the coil part 40 in the first and second cover units 51 and 52.

The anisotropic metal powder 61a is included in the upper and lower portions of the coil unit 40 in the first and second cover units 51 and 52, and the isotropic metal powder 71 is included in the upper and lower portions of the core part 55 in the first and second cover units 51 and 52.

The anisotropic metal powder 61a included in the upper and lower portions of the coil unit 40 in the first and second cover units 51 and 52 is arranged such that one axis of a plate-shaped plane 61′ is perpendicular to the thickness (t) direction of the coil unit 40 so as to be oriented in the flow direction of magnetic flux.

In FIG. 2, it is illustrated that both the first and second cover units 51 and 52 include the anisotropic metal powder 61a, but without being limited thereto and at least one of the first and second cover units 51 and 52 may include the anisotropic metal powder 61a.

Also, the coil component 100 according to an exemplary embodiment in the present disclosure includes the anisotropic metal powder 61b in the core part 55.

The anisotropic metal powder 61b included in the core part 55 is arranged such that one axis of a plate-shaped plane 61′ thereof is parallel to the thickness (t) direction of the coil unit 40 so as to be oriented in the flow direction of magnetic flux.

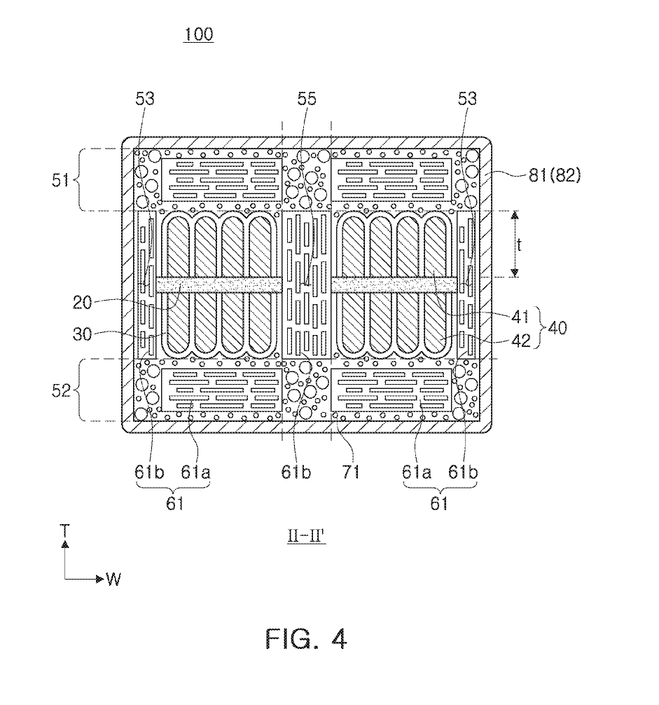

FIG. 4 is a cross-sectional view of the coil component of FIG. 1, taken along line II-II′ of FIG. 1.

Referring to FIG. 4, the coil component 100 according to an exemplary embodiment of the present disclosure includes the anisotropic metal powder 61b in the core part 55 in the middle of the coil unit 40, and includes the anisotropic metal powder 61b also in an outer circumferential portion 53 outside of the coil unit 40.

Like the anisotropic metal powder 61b included in the core part 55, the anisotropic metal powder 61b included in the outer circumferential portion 53 is arranged to be parallel to the thickness (t) direction of the coil unit 40, and thus, one axis of a plate-shaped plane 61′ may be oriented in the flow direction of magnetic flux.

As shown in FIG. 4, outer circumferential portions 53 formed at outer surfaces of the coil unit 40 include the anisotropic metal powder 61b, but without being limited thereto and at least one of the outer circumferential portions 53 formed on sides of the coil unit 40 may include the anisotropic metal powder 61b.

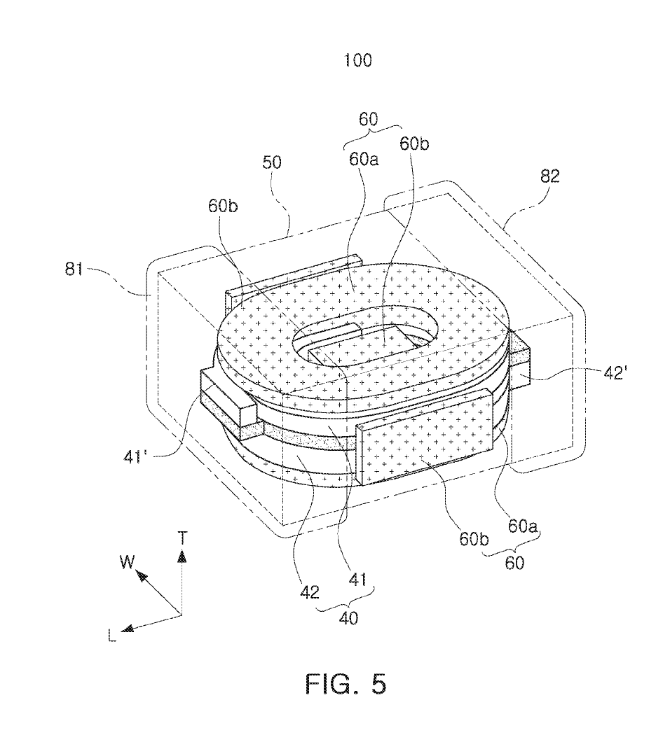

FIG. 5 is a perspective view illustrating a coil component such that a coil unit 40 and a sheet 60 including anisotropic metal powder 61 are illustrated according to an exemplary embodiment in the present disclosure.

Referring to FIG. 5, in the coil component 100 according to an exemplary embodiment in the present disclosure, a sheet 60 including the anisotropic metal powder 61 is disposed around the coil unit 40.

As illustrated in FIG. 5, toroidal sheets 60a including an anisotropic metal powder 61a are disposed above and below the coil unit 40 such that the anisotropic metal powder 61a is included in regions corresponding to the coil unit 40 in the first and second cover units 51 and 52.

The anisotropic metal powder 61a included in the toroidal sheets 60a is arranged such that one axis of a plate-shaped plane 61′ thereof is perpendicular to the thickness (t) direction of the coil unit 40.

Also, the sheet 60b including the anisotropic metal powder 61b is disposed in the core part 55 in the middle of the coil unit 40 and at the outer circumferential portion 53 outside of the coil unit 40 to allow the anisotropic metal powder 61b to be included in the core part 55 and the outer circumferential portion 53.

The anisotropic metal powder 61b included in the sheet 60b disposed in the core part 55 and at the outer circumferential portion 53 is arranged such that one axis of a plate-shaped plane 61′ thereof is parallel to the thickness (t) direction of the coil unit 40.

By disposing the sheet 60 including the anisotropic metal powder 61b and filling the other portion with the sheet including the isotropic metal powder 71, the magnetic body 50 surrounding the coil unit 40 may be formed.

Since the toroidal sheets 60a including the anisotropic metal powder 61a are disposed above and below the coil unit 40, the upper portion and the lower portion of the core part 55 in the first and second cover units 51 and 52 may be filled with the isotropic metal powder 71.

As shown in FIG. 5, the sheets 60 having a specific shape including the anisotropic metal powder 61 are formed to realize a structure of the coil component 100 according to an exemplary embodiment in the present disclosure. However, without being limited thereto, any method may be used as long as it the structure of the coil component 100 according to an exemplary embodiment of the present disclosure described above can be realized thereby.

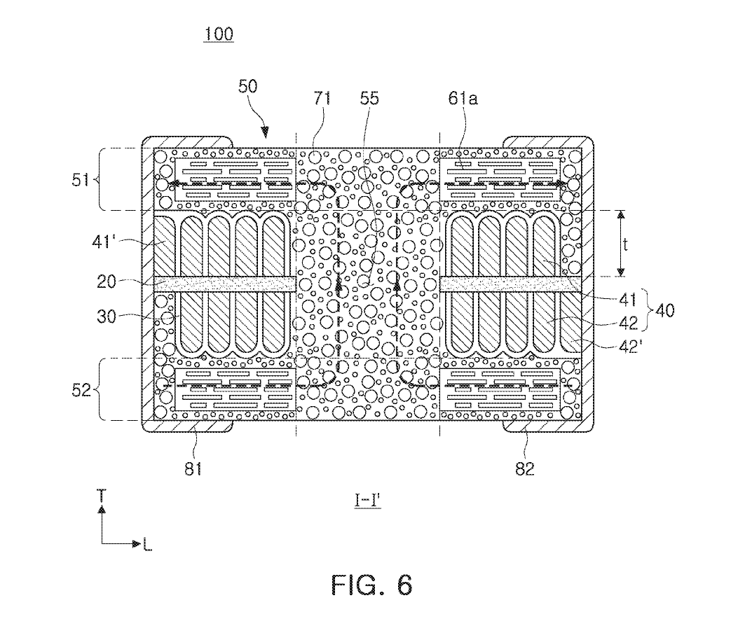

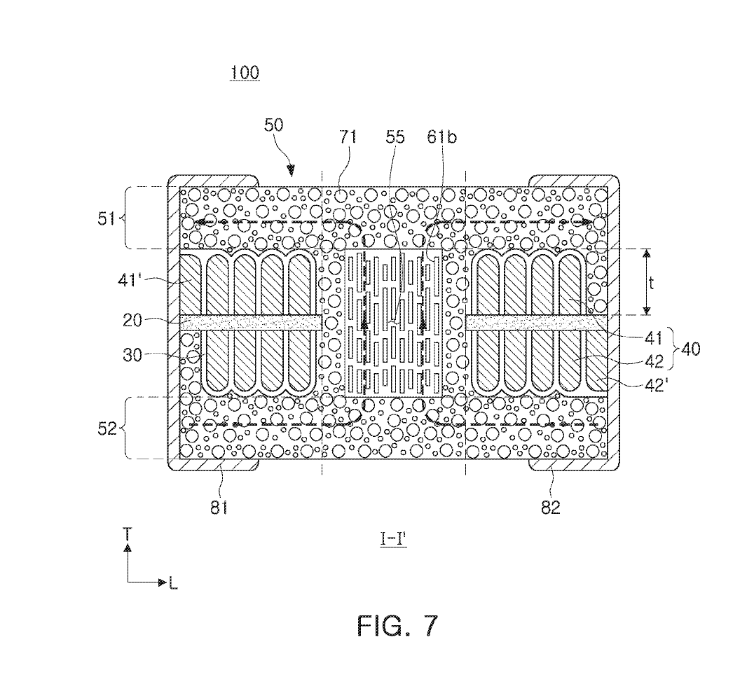

FIGS. 6 and 7 are cross-sectional views of a coil component in the length and thickness (L-T) directions according to additional exemplary embodiments in the present disclosure.

Referring to FIG. 6, in the coil component 100 according to an exemplary embodiment of the present disclosure, the upper portion and the lower portion of the coil unit 40 in the first and second cover units 51 and 52 include the anisotropic metal powder 61a, and portions of the first and second cover units 51 and 52 excluding the upper portion and the lower portion of the coil unit 40 include the isotropic metal powder 71. That is, the upper portion and the lower portion of the core part 55, the core part 55, and the outer circumferential portion 53 include the isotropic metal powder 71.

The anisotropic metal powder 61a included in the regions corresponding to the coil unit 40 in the first and second cover units 51 and 52 may be arranged such that one axis of a plate-shaped plane 61′ is perpendicular to the thickness (t) direction of the coil unit 40, and thus, one axis of a plate-shaped plane 61′ may be oriented in a flow direction of magnetic flux.

In another exemplary embodiment of the present disclosure illustrated in FIG. 6, the same configuration as that of the coil component 100 according to the exemplary embodiments in the present disclosure described above may be applied in the same manner, except that the isotropic metal powder 71 is included in the core part 55 and the outer circumferential portion 53.

Referring to FIG. 7, the coil component 100 according to the exemplary embodiments in the present disclosure includes the anisotropic metal powder 61b in the core part 55, and the isotropic metal powder 71 in the first and second cover units 51 and 52. Also, although not shown, the anisotropic metal powder 61b may also be included in the outer circumferential portion 53.

The anisotropic metal powder 61b included in the core part 55 may be arranged such that one axis of a plate-shaped plane 61′ is parallel to the thickness (t) direction of the coil unit 40 and is oriented in a flow direction of magnetic flux.

In another exemplary embodiment of the present disclosure illustrated in FIG. 7, the same configuration as that of the coil component 100 according to the exemplary embodiments in the present disclosure described above may be applied in the same manner, except that the isotropic metal powder 71 is included in the entirety of the first and second cover units 51 and 52.

Method of Manufacturing Coil Component

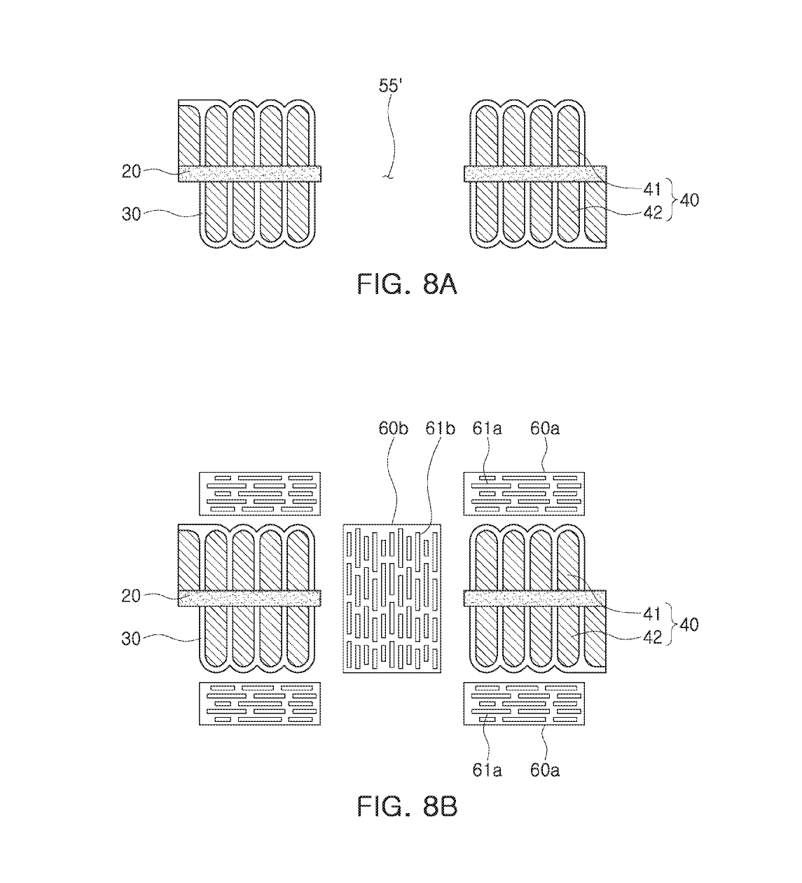

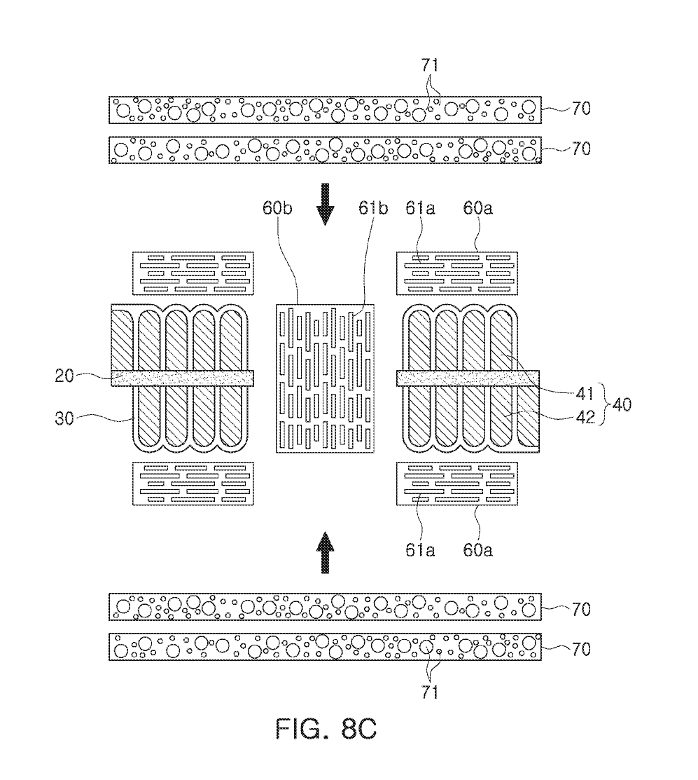

FIGS. 8A through 8C are views sequentially illustrating a process of manufacturing a coil component according to an exemplary embodiment in the present disclosure.

Referring to FIG. 8A, first, a coil unit 40 is formed.

A via hole (not shown) may be formed in a substrate 20, plating resist (not shown) having an opening may be formed on the substrate 20, and the via hole and the opening may be filled with a conductive metal through plating to form first and second coil conductors 41 and 42, and a via (not shown) connecting the first and second coil conductors 41 and 42.

The first and second coil conductors 41 and 42 and the via may be formed of a conductive metal having excellent electrical conductivity. For example, the first and second coil conductors 41 and 42 may be formed of silver (Ag), palladium (Pd), aluminum (Al), nickel (Ni), titanium (Ti), gold (Au), copper (Cu), platinum (Pt), or alloys thereof.

The method of forming the coil unit 40 is not limited to the plating method. The coil unit may be formed with a metal wire and any type of a coil unit may be applied as long as magnetic flux can be generated by applying a current thereto.

An insulating film 30 may be formed to cover the first and second coil conductors 41 and 42.

The insulating film 30 may include, for example, a polymer material such as an epoxy resin or a polyimide resin, photoresist (PR), or a metal oxide, but the material of the insulating film 30 is not limited thereto and any insulating material may be applied as long as it can surround the first and second coil conductors 41 and 42 to prevent short circuits.

The insulating film 30 may be formed through a screen printing method, a method of exposing and developing photoresist, a spray application method, or a method of oxidizing the coil conductor through chemical etching, or the like.

A central portion of a region of the substrate 20 in which the first and second coil conductors 41 and 42 are not formed may be removed to form a core part hole 55′.

The substrate 20 may be removed through mechanical drilling, laser drilling, sand blasting, or punching machining.

Referring to FIG. 8B, sheets 60a and 60b respectively including anisotropic metal powder particles 61a and 61b may be disposed around a coil unit 40.

The sheets 60a and 60b may be manufactured by mixing a thermosetting resin and an organic material such as a binder or a solvent with the anisotropic metal powder particles 61a and 61b to prepare a slurry, applying the slurry to a carrier film through a doctor blade method, and drying the slurry.

The sheets 60a and 60b may be manufactured such that the anisotropic metal powder particles 61a and 61b are dispersed in the thermosetting resin such as epoxy or polyimide.

As illustrated in FIG. 8B, the toroidal sheet 60a including the anisotropic metal powder 61a is disposed above and below the coil unit 40 such that a region corresponding to the coil unit 40 in the first and second cover units 51 and 52 includes the anisotropic metal powder 61a.

The anisotropic metal powder 61a included in the toroidal sheet 60a is arranged such that at least one axis of a plate-shaped plane 61′ is perpendicular to the thickness (t) direction of the coil unit 40.

Also, the sheet 60b including the anisotropic metal powder 61b is disposed in the core part hole 55′ in the middle of the coil unit 40 such that the core part 55 includes the anisotropic metal powder 61b.

Although not shown in FIG. 8B, the sheet 60b including the anisotropic metal powder 61b may also be disposed in an outer circumferential portion hole outside of the coil unit 40 to allow the outer circumferential portion 53 to include the anisotropic metal powder 61b.

The anisotropic metal powder 61b included in the sheet 60b positioned at the core part 55 and the outer circumferential portion 53 is arranged such that one axis of a plate-shaped plane 61′ is parallel to the thickness (t) direction of the coil unit 40.

As shown in FIG. 8B, the sheets 60a and 60b having a specific shape including the anisotropic metal powder particles 61a and 61b are disposed in the regions corresponding to the coil unit 40 in the first and second cover units 51 and 52 and the core part hole 55′ to manufacture the coil component 100 according to an exemplary embodiment in the present disclosure. However, without being limited thereto, any method may be applicable as long as the method may realize a structure of the coil component 100 according to an exemplary embodiment in the present disclosure.

Referring to FIG. 8C, sheets 70 including isotropic metal powder 71 are stacked above and below the coil unit 40 and compressed and cured to forma magnetic body 50 surrounding the coil unit 40.

The sheet 70 may be manufactured by mixing a thermosetting resin and an organic material such as a binder or a solvent with the isotropic metal powder 71 to prepare a slurry, applying the slurry to a carrier film to have a thickness of tens of μm through a doctor blade method, and drying the slurry.

The sheet 70 is manufactured such that the isotropic metal powder 71 is dispersed in the thermosetting resin such as epoxy or polyimide.

The sheet 70 including the isotropic metal powder 71 is stacked above and below the coil unit 40, and compressed and cured to fill portions, excluding the portion where the sheet 60 including the anisotropic metal powder 60 is disposed, with the isotropic metal powder 71.

As illustrated in FIG. 8C, when the sheet 70 including the isotropic metal powder 71 is stacked after the toroidal sheets 60a including the anisotropic metal powder 61a are disposed above and below the coil unit 40, the upper portion and the lower portion of the core part 55 in the first and second cover units 51 and 52 may be filled with the isotropic metal powder 71.

In FIGS. 8B and 8C, the sheets 60a including the anisotropic metal powder 61a are first disposed above and below the coil unit 40, and the sheet 70 including the isotropic metal powder 71 is stacked is illustrated, but the present disclosure is not limited thereto. For example, the sheets 70 including the isotropic metal powder 71 may be stacked above and below the coil unit 40, the sheet 60a including the anisotropic metal powder 61a may be then disposed, and thereafter, the sheets 70 including the isotropic metal powder 71 may be stacked again.

The process of forming the magnetic body 50 surrounding the coil unit 40 by stacking the sheet 60 including the anisotropic metal powder 61 and the sheet 70 including the isotropic metal powder 71 through the method of manufacturing a coil component according to an exemplary embodiment in the present disclosure has been described, but, without being limited thereto, any method may be applicable as long as it allows for the formation of a metal powder-resin complex having the coil component 100 structure according to an exemplary embodiment in the present disclosure.

Thereafter, the first and second external electrodes 81 and 82 are formed on external surfaces of the magnetic body 50 such that the first and second external electrodes 81 and 82 are connected to the coil unit 40.

Repeated descriptions of the characteristics of the coil component according to an exemplary embodiment in the present disclosure, excluding the above descriptions, will be omitted here.

As set forth above, according to exemplary embodiments of the present disclosure, high inductance may be secured, an excellent Q factor and excellent DC-bias characteristics may be obtained.

While exemplary embodiments have been shown and described above, it will be apparent to those skilled in the art that modifications and variations could be made without departing from the scope of the present invention as defined by the appended claims.

What is claimed is:

1. A coil component comprising a coil unit surrounded by a magnetic body,
wherein the magnetic body includes anisotropic metal powder and isotropic metal powder, and
upper and lower cover units with the coil unit interposed therebetween,
wherein the anisotropic metal powder is arranged such that one axis of a plate-shaped plane thereof is oriented in a flow direction of magnetic flux, and
central regions of the upper and lower cover units comprise the isotropic metal powder.

2. The coil component of claim 1, wherein the anisotropic metal powder is comprised in at least one of the upper cover unit and the lower cover unit in a region corresponding to the coil unit.

3. The coil component of claim 2, wherein the anisotropic metal powder is arranged such that one axis of a plate-shaped plane thereof is perpendicular to a thickness direction of the coil unit.

4. The coil component of claim 1, wherein the anisotropic metal powder is comprised in a core part formed in the middle of the coil unit.

5. The coil component of claim 1, wherein the anisotropic metal powder is comprised in an outer circumferential portion formed on an outer surface of the coil unit.

6. The coil component of claim 4, wherein the anisotropic metal powder is arranged such that one axis of a plate-shaped plane thereof is parallel to a thickness direction of the coil unit.

7. The coil component of claim 5, wherein the anisotropic metal powder is arranged such that one axis of a plate-shaped plane thereof is parallel to a thickness direction of the coil unit.

8. The coil component of claim 1, wherein the anisotropic metal powder is comprised in a toroidal sheet and disposed in a region corresponding to the coil unit in the first and second cover units.

9. The coil component of claim 1, wherein the anisotropic metal powder and the isotropic metal powder are included in a thermosetting resin in a dispersed manner.

10. A method of manufacturing a coil component, the method comprising:
forming a coil unit; and
surrounding the coil unit with a magnetic body comprising anisotropic metal powder and isotropic metal powder,
wherein the anisotropic metal powder is arranged such that one axis of a plate-shaped plane thereof is oriented in a flow direction of magnetic flux, and the isotropic metal powder is comprised in central regions of first and second cover units disposed with the coil unit interposed therebetween.

11. The method of claim 10, wherein the anisotropic metal powder is comprised in at least one of the upper cover unit and the lower cover unit in a region corresponding to the coil unit.

12. The method of claim 10, wherein a toroidal sheet comprising the anisotropic metal powder is disposed in a region corresponding to the coil unit in the first and second cover units.

13. The method of claim 11, wherein the anisotropic metal powder is arranged such that one axis of a plate-shaped plane thereof is perpendicular to a thickness direction of the coil unit.

14. The method of claim 12, wherein the anisotropic metal powder is arranged such that one axis of a plate-shaped plane thereof is perpendicular to a thickness direction of the coil unit.

15. The method of claim 10, wherein sheets comprising the anisotropic metal powder are disposed in a core part formed in the middle of the coil unit and at an outer circumferential portion of the coil unit.

16. The method of claim 15, wherein the anisotropic metal powder is arranged such that one axis of a plate-shaped plane thereof is parallel to the thickness direction of the coil unit.
